(19) United States
(12) Patent Application Publication
(10) Pub. No.: US 2015/0056001 A1
(43) Pub. Date: Feb. 26, 2015

(54) MECHANICAL OVERLOAD FUSE FOR STEERING LINKAGE

(71) Applicant: Powers and Sons, LLC, Montpelier, OH (US)

(72) Inventors: Gene J. Messenger, Novi, MI (US); Christopher Fink, Archbold, OH (US); Matthew L. Dudeck, Ann Arbor, MI (US); Charles E. Letts, III, Ann Arbor, MI (US); Peter Karkos, Ann Arbor, MI (US)

(21) Appl. No.: 14/466,434

(22) Filed: Aug. 22, 2014

Related U.S. Application Data
(60) Provisional application No. 61/959,350, filed on Aug. 22, 2013.

(51) Int. Cl. F16D 9/06; B62D 3/02

(52) U.S. Cl. CPC F16D 9/06; B62D 3/02
USPC 403/2

(57) ABSTRACT

A mechanical fuse adapted for use in a vehicle steering linkage assembly including an outer housing, an inner housing coaxially arranged within the outer housing, a first crushable element arranged within the outer housing configured to crush under excessive axial compressive loads, and a second crushable element arranged within the outer housing configured to crush under excessive axial tensile loads, wherein the fuse operates normally in an uncrushed state and allows unwanted motion in a crushed state, thereby alerting a driver to an overload condition.

### CROSS-REFERENCE TO RELATED APPLICATION

This application claims priority from U.S. Provisional Application No. 61/959,350 filed Aug. 22, 2013, the contents of which are incorporated herein by reference.

### TECHNICAL FIELD AND BACKGROUND OF THE INVENTION

The present invention relates generally to a mechanical fuse for a steering linkage assembly, and more particularly, to a mechanical fuse arranged in the steering linkage of a vehicle configured to fail in response to compressive and tensile overload conditions in order to protect the steering gear from damage and indicate to the driver the occurrence of an overload condition.

Vehicle steering is typically controlled through mechanical linkage configured to translate steering wheel movement to the front wheels. One example of a conventional steering linkage is a rack and pinion system in which a shaft from the steering wheel rotates to turn a pinion gear, in turn causing a rack to move side to side thereby pushing tie rod ends and steering arms to turn the wheels. Another example of a steering linkage is a parallel linkage in which the steering wheel shaft turns a gear to rotate a pitman arm. The pitman arm is connected to a center link that moves side to side. The side to side motion causes tie rod end/sleeve assemblies and steering arms to move to turn the wheels. Yet another example of a steering linkage is a Haltenberger linkage in which the steering wheel shaft turns a gear to rotate a pitman arm. The rotating pitman arm moves a drag link side to side, thereby moving tie rod ends and steering arms to turn the wheels in the appropriate direction.

Each of the above exemplary linkage systems are engineered to operate properly and safely within a defined range of vehicles, loads and forces. In the event that the vehicle is loaded beyond its maximum capacity or the vehicle encounters forces beyond the engineered maximum, collectively referred to herein as “overloading” or an “overload condition,” damage to the vehicle steering gear can occur. Operating a vehicle with a damaged steering gear creates significant safety concerns for the vehicle occupants as well as to those persons around it.

Therefore, what is needed is a solution to improve driver recognition of an overload condition.

### BRIEF SUMMARY OF THE INVENTION

It is an object of the present invention to provide a mechanical overload fuse configured to fail under predetermined maximum axial compressive and tensile forces on the mechanical fuse.

It is another object of the invention to provide a mechanical fuse adapted for use in a vehicle steering linkage assembly.

It is another object of the invention to provide a mechanical fuse for a steering linkage assembly configured to accommodate compressive and tensile forces below predetermined maximum levels, and fail in the event those maximum force levels are exceeded.

It is another object of the invention to provide a mechanical fuse for a steering linkage assembly configured to provide wanted steering linkage motion under normal load conditions and fail under maximum axial compressive and tensile forces on the mechanical fuse (e.g., when predetermined maximum force levels are exceeded), thereby allowing unwanted motion in the assembly which alerts the driver that the steering system is damaged.

To achieve the foregoing and other objects and advantages, in a first embodiment the present invention provides a mechanical overload fuse including an outer housing, an inner housing arranged coaxially within the outer housing, a first crushable element positioned between a first end of the inner housing and the outer housing configured to crush when a predetermined maximum axial compressive load is exceeded, and a second crushable element positioned between a second end of the inner housing and the outer housing configured to crush when a predetermined maximum axial tensile load is exceeded, wherein the first and second crushable elements are resistant to crushing under loads below the predetermined maximum axial compressive and tensile loads, and crush when the predetermined maximum axial compressive and tensile loads are exceeded, thereby introducing an air gap in the mechanical overload fuse resulting in unwanted play.

In a further aspect, the mechanical fuse may be adapted for use in a vehicle steering linkage assembly.

In a further aspect, the outer housing may be fixed to a first half of a rigid link of the vehicle steering linkage assembly and the inner housing may be fixed to a second half of the rigid link of the vehicle steering linkage assembly, and wherein the mechanical fuse may space apart the first and second halves of the rigid link.

In a further aspect, the mechanical fuse may include a first clamp for fixing the outer housing to the first half of the rigid link and a second clamp for fixing the inner housing to the second half of the rigid link.

In a further aspect, the crushed state of the mechanical fuse may impart “play” into the vehicle steering linkage assembly, thereby alerting a vehicle driver to the occurrence of an overload condition.

In a further aspect, the inner housing may include a spring captured between spaced flanges configured to accommodate forces in the mechanical fuse below the predetermined maximum axial compressive and tensile forces (i.e., “normal” forces).

In a further aspect, the first and second crushable elements may take the form of annular washers constructed from aluminum honeycomb and like materials.

In a further aspect, a crushed state of either one of the first and second crushable elements resulting from excess forces on the mechanical fuse may result in an air gap between the inner and outer housings allowing relative movement between the inner and outer housings.

In a further aspect, the outer housing may be a cylindrical tubular body further including a removable end cap.

In another embodiment, provided herein is a mechanical fuse adapted for use in a vehicle steering linkage assembly and including an outer housing, an inner housing coaxially arranged within the outer housing, a first crushable element arranged within the outer housing configured to crush under a predetermined maximum axial compressive force on the mechanical fuse, and a second crushable element arranged within the outer housing spaced from the first crushable element and configured to crush under a predetermined maximum axial tensile force on the mechanical fuse. Axial compressive and tensile forces on the mechanical fuse below the predetermined maximum axial compressive and tensile forces are managed by the inner housing, and relative axial movement between the inner and outer housings occurs in a crushed state of the mechanical fuse thereby imparting play into the mechanical fuse and the vehicle steering linkage assembly.

In a further aspect, the outer housing may be fixed to a first half of a rigid link of the vehicle steering linkage assembly and the inner housing may be fixed to a second half of the rigid link of the vehicle steering linkage assembly, and wherein the mechanical fuse may space apart the first and second halves of the rigid link.

In a further aspect, the mechanical fuse may include a first clamp for fixing the outer housing to the first half of the rigid link and a second clamp for fixing the inner housing to the second half of the rigid link.

In a further aspect, the first crushable element in a crushed state may provide an air gap between a first end of the inner housing and a first end of the outer housing, and the second crushable element in a crushed state may provide an air gap between a second end of the inner housing and a second end of the outer housing.

In a further aspect, the inner housing may include a spring captured between spaced flanges configured to accommodate forces in the mechanical fuse below the predetermined maximum axial compressive and tensile forces.

In yet another embodiment, a vehicle steering linkage assembly is provided herein and includes a rigid steering link separated into first and second spaced halves, and a mechanical fuse interconnecting the first and second spaced halves. The mechanical fuse includes an outer tubular housing, an inner housing arranged coaxially within the outer tubular housing, and first and second spaced crushable elements arranged at opposing ends of the inner housing configured to crush under respective predetermined maximum axial compressive and tensile forces on the mechanical fuse, wherein relative axial movement between the inner and outer housings occurs in a crushed state of the mechanical fuse thereby imparting play into the mechanical fuse and the vehicle steering linkage assembly.

In a further aspect, the first crushable element may be positioned between a first end of the inner housing and a first end of the outer tubular housing, and the second crushable element may be positioned between a second end of the inner housing and a second end of the outer tubular housing.

In a further aspect, the rigid steering link may be any component of the steering system operable for connecting suspension components, e.g., a drag link or a tie rod.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

Features, aspects and advantages of the present invention are better understood when the following detailed description of the invention is read with reference to the accompanying drawings, in which:

FIG. 1 is an isometric view of a steering link fitted with a mechanical overload fuse according to an embodiment of the invention;

FIG. 2 is an isometric view of the mechanical overload fuse;

FIG. 3 is a side elevation of the mechanical overload fuse;

FIG. 4 is an end view of the mechanical overload fuse;

FIG. 5 is a sectional view through the mechanical overload fuse taken along line 5-5 of FIG. 4;

FIG. 6 is an exploded perspective view of the mechanical overload fuse;

FIG. 7 is a schematic illustration of the mechanical overload fuse shown in a standard state;

FIG. 8 is a schematic illustration of the mechanical overload fuse shown in an overloaded tensile state; and

FIG. 9 is a schematic illustration of the mechanical overload fuse shown in an overloaded compressed state.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

Referring to the figures, a mechanical fuse adapted for use in a vehicle steering linkage system is shown generally at reference numeral 20. The mechanical fuse is generally configured to fail under a predetermined maximum load or range of loads, thereby causing a change to the steering motion upon and thereafter maximum loading. The mechanical fuse is bi-directional, meaning that it is configured to fail under both excessive tensile and compressive forces. The result of an exceeded force in either direction is the ultimate failure of the fuse and unwanted motion within the assembly and consequently the steering linkage. This unwanted motion will alert the driver that the mechanical fuse and/or steering system have been damaged and require service.

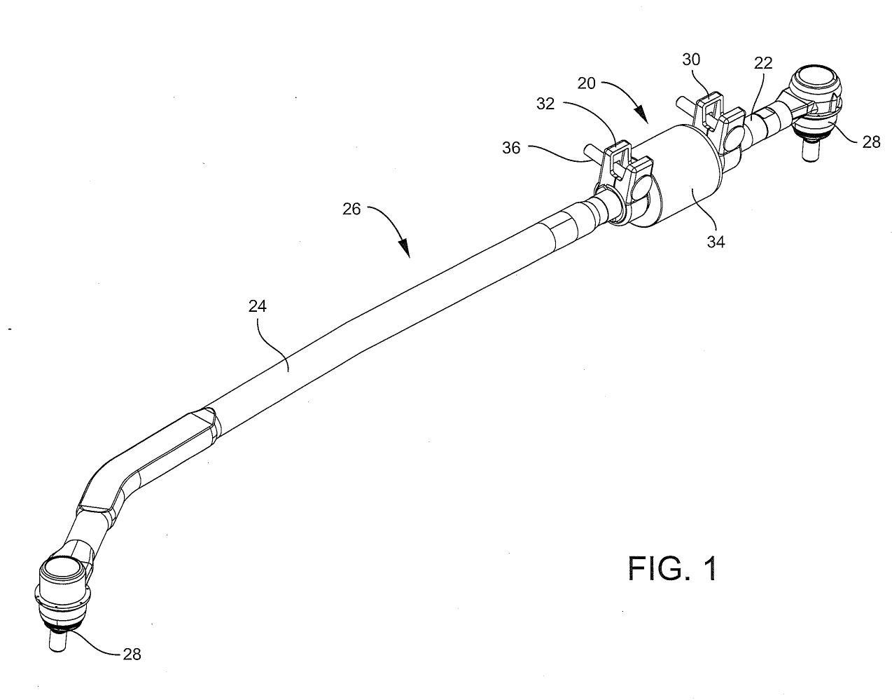

Referring to FIG. 1, the mechanical fuse 20 is shown connecting separate halves 22, 24 of a rigid link 26 of a vehicle steering linkage assembly. While the exemplary rigid link 26 shown is a drag link, the mechanical fuse is adapted for use with any component of a steering system responsible for connecting suspension components. Known to those skilled in the art, a drag link may connect at one end to a pitman arm and at the opposing end to a tie rod assembly. Drag link attachment points preferably include ball joints 28 that provide free kinematic motion.

A conventional drag link assembly typically includes an adjuster sleeve for interconnecting the two separate halves of the drag link. The adjuster sleeve is configured to allow the halves to be advanced into or withdrawn from the adjuster sleeve to adjust the overall length of the assembly. Once installed, the length of the assembly is fixed and rigid, and therefore incapable of accommodating excessive forces. In the event of overloading, one or more of the drag link halves and adjuster sleeve may be damaged resulting in an unsafe driving condition. In comparison, the mechanical fuse of the present invention is configured to fail to protect the steering gear from damage and alert the driver to the overload condition while still allowing the vehicle to be driven, albeit with an unwanted steering motion.

First and second clamps 30, 32 arranged at opposing ends of the mechanical fuse 20 serve to fix the first half 22 of the drag link relative to an outer housing 34 of the fuse, and the second half 24 of the drag link relative to an inner housing of the fuse, respectively. The first and second halves 22, 24 are spaced apart such that the fuse operates to allow relative axial motion between the inner and outer housings under normal and overload conditions. As shown, the first and second clamps 30, 32 clamp around neck portions of the respective inner and outer housings through which the first and second drag links halves 22, 24 are inserted. The clamps 30, 32 may be tightened around the neck portions by advancing fasteners 36 through the free ends of the clamps.

The drag link assembly 26 may be assembled and provided as a complete unit including the mechanical fuse 20 for original equipment and retrofit applications. In other applications, the mechanical fuse 20 may be a stand-alone component to be installed on an existing drag link assembly. In yet another application, the drag link assembly 26 including the mechanical fuse 20 may be provided as a part of a complete steering linkage assembly. The mechanical fuse 20 is preferably packaged and dimensioned to fit within the space constraints allocated to the steering linkage in a motor vehicle, for example, underneath the front of the vehicle.

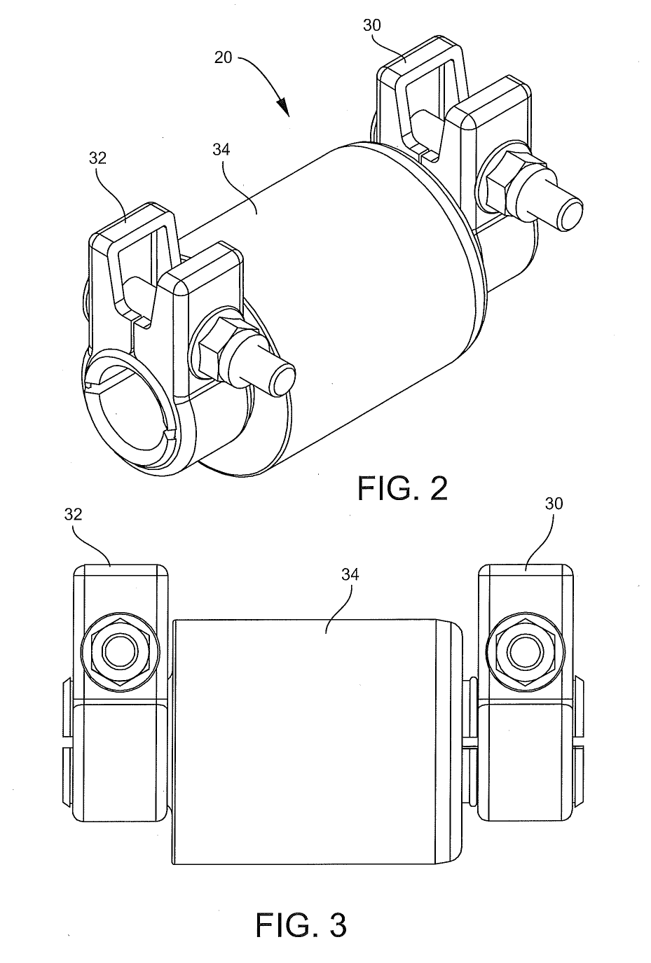

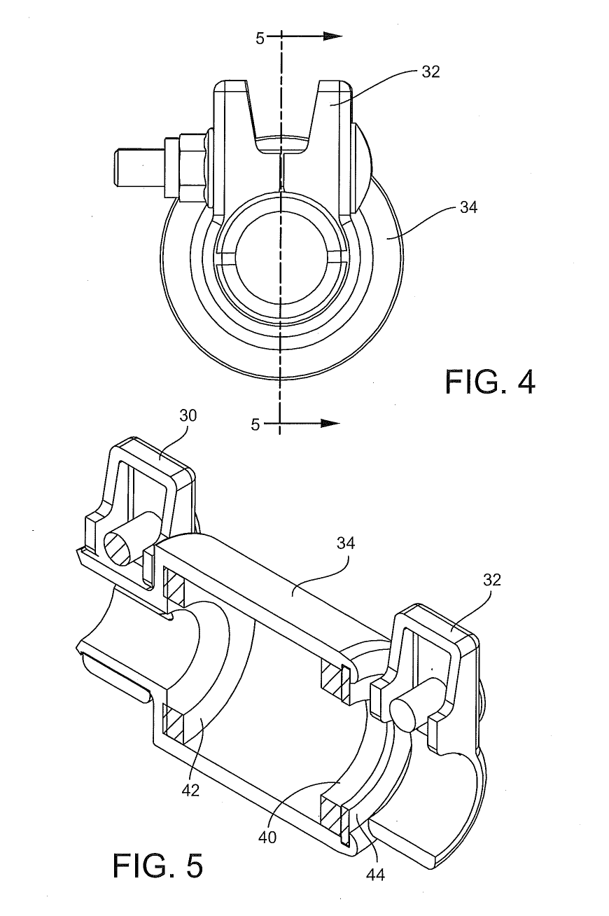

Referring to FIGS. 2-5, the mechanical fuse 20 generally includes an outer housing 34, an inner housing 38 arranged coaxially within the outer housing, and first and second crushable elements 40, 42 arranged within the outer housing such that the elements crush (i.e., fail) as a result of relative movement between the inner and outer housings in response to excess forces. The outer housing 34 is a cylindrical tubular body having a separate end cap 44 at one end for assembling the inner housing 38 within the outer housing. As best shown in FIG. 5, the end cap 44 may take the form of an annular spacer retained within a groove around the inner circumference of the outer housing 34. The end cap 44 defines a central opening through which the neck portion of the inner housing 38 passes to allow relative axial motion between the inner and outer housings in response to compressive and tensile forces on the fuse.

The outer housing 34 defines an interior volume in which the inner housing 38 and first and second crushable elements 40, 42 are maintained and arranged coaxially. The first and second crushable elements 40, 42 are positioned at opposing ends of the outer housing 34 with the inner housing 38 positioned therebetween. The first and second crushable elements 40, 42 abut against the outer housing end wall and the end cap 44, respectively, and abut against the opposing ends of the inner housing 38, which in a specific embodiment may take the form of a piston. The crushable elements 40, 42 are dimensioned such that, in an uncrushed state, no air gaps are provided between the elements and the piston and/or the elements and the outer housing. In a crushed state, the crushable elements 40, 42 are compacted in the axial direction, consequently introducing air gaps at the ends of the inner housing 38 that allow unwanted relative axial motion (i.e., “play”) between the inner and outer housings as discussed in detail below.

The first and second crushable elements 40, 42 may take the form of annular rings. The crushable elements 40, 42 may be constructed from aluminum honeycomb and like materials including materials with cells configured to collapse on themselves to absorb energy. Crushable materials may be selected based upon the envisioned forces to be encountered, application and predicted load. The mechanical fuse may be “tuned” by selecting certain crushable materials based on the ability of the material to yield under different predetermined loads.

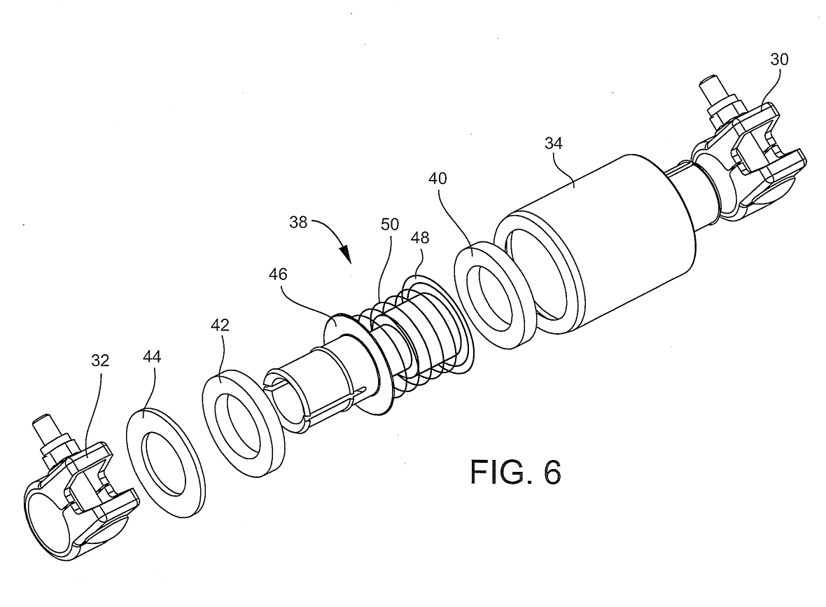

Referring to FIG. 6, the exploded view of the mechanical fuse assembly 20 illustrates the relationship and arrangement of the various components. The first crushable element 40 is positioned at one end of the outer housing 34 between the end wall of the outer housing and the leading end of the inner housing 38. The second crushable element 42 is positioned at the opposing end of the housing between the trailing end of the inner housing 38 and the end cap 44. In this spaced arrangement, the first crushable element 40 is configured to crush under excessive axial compressive overloading and the second crushable element 42 is configured to crush under excessive axial tensile overloading.

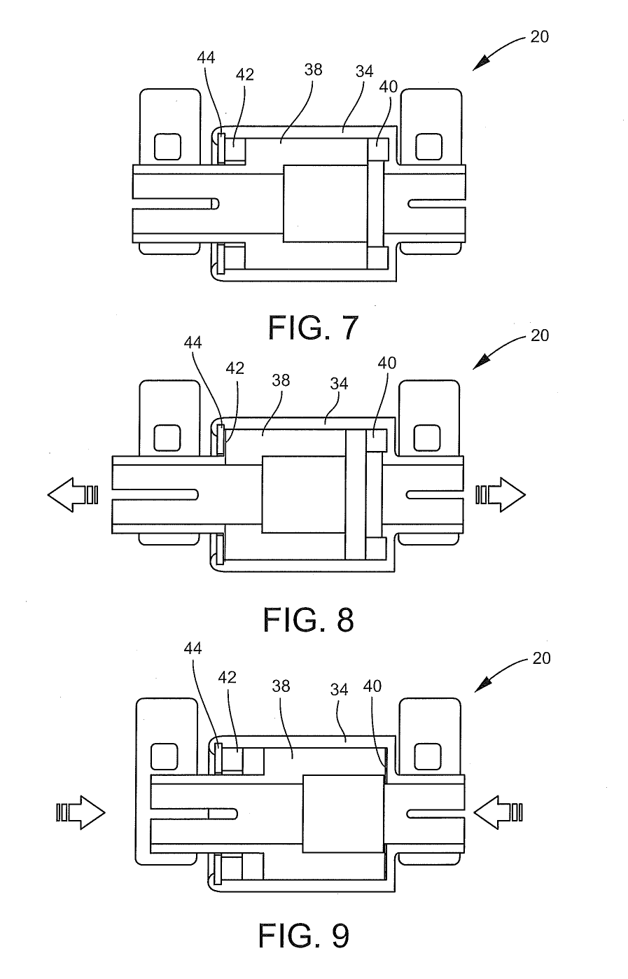

In one embodiment, the inner housing 38 may take the form of a rigid link in which relative axial displacement between the inner and outer housings is prevented in an uncrushed state of the mechanical fuse. As shown in FIG. 6, the inner housing 38 includes spaced first and second flanges 46, 48 arranged to maintain a resilient spring 50 therebetween. In normal operation (i.e., uncrushed state), the spring 50 allows the mechanical fuse 20 to absorb and recover from compressive and tensile loading forces below predetermined maximum levels, thereby providing standard motion in the assembly and a normal steering motion. Referring to FIG. 7, the mechanical fuse 20 performs in a standard state under all loads not exceeding the predetermined maximum compressive and tensile loads. In the standard state, the arrangement of the outer housing 34, first crushable element 40, inner housing 38, second crushable element 42 and end cap 44 is continuous without any air gaps therebetween, resulting in a normal steering motion.

Referring to FIG. 8, the mechanical fuse 20 is shown in an overloaded tensile state in which the axial tensile load is greater than the predetermined maximum tensile load. In the overloaded tensile state, the second crushable element 42 is crushed between one end of the inner housing 38 and the end cap 44 as the inner and outer housings move apart. The crushed element introduces an air gap between the inner housing and the end cap that imparts permanent unwanted motion (i.e., play) in the mechanical fuse and a resulting unwanted steering motion.

Referring to FIG. 9, the mechanical fuse 20 is shown in an overloaded compressive state in which the axial compressive load is greater than the predetermined maximum compressive load. In the overloaded compressive state, the first crushable element 40 is crushed between the end of the inner housing 38 and the end wall of the outer housing 34 as the inner housing is advanced into the outer housing. The crushed element introduces a permanent air gap between the inner housing and the end wall that imparts play in the mechanical fuse and an unwanted steering motion.

The first and second crushable elements 40, 42 are resistant to crushing under loads below predetermined maximum loads. Under excessive forces (i.e., overloading), the crushable elements are crushed to a degree that alerts the driver to the crushed (i.e., damaged) state of the fuse. The fuse may be repaired by replacing one or more of the crushed elements and/or the complete assembly.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A mechanical overload fuse, comprising:
an outer housing;
an inner housing arranged coaxially within the outer housing;
a first crushable element positioned between a first end of the inner housing and the outer housing configured to crush when a predetermined maximum axial compressive load is exceeded; and
a second crushable element positioned between a second end of the inner housing and the outer housing configured to crush when a predetermined maximum axial tensile load is exceeded;
wherein the first and second crushable elements are resistant to crushing under loads below the predetermined maximum axial compressive and tensile loads, and crush when the predetermined maximum axial compressive and tensile loads are exceeded, thereby introducing an air gap in the mechanical overload fuse resulting in play between the inner and outer housings.

2. The mechanical fuse of claim 1, wherein the mechanical overload fuse is adapted for use in a vehicle steering linkage assembly.

3. The mechanical fuse of claim 2, wherein the outer housing is fixed to a first half of a rigid link of the vehicle steering linkage assembly and the inner housing is fixed to a second half of the rigid link of the vehicle steering linkage assembly, and wherein the mechanical overload holds the first and second halves of the rigid link spaced apart.

4. The mechanical fuse of claim 3, further comprising a first clamp for fixing the outer housing to the first half of the rigid link and a second clamp for fixing the inner housing to the second half of the rigid link.

5. The mechanical fuse of claim 2, wherein a crushed state of the mechanical fuse imparts play into the vehicle steering linkage assembly, thereby alerting a vehicle driver to the occurrence of an overload condition.

6. The mechanical fuse of claim 1, wherein the inner housing comprises a spring captured between spaced flanges configured to accommodate forces in the mechanical fuse below the predetermined maximum axial compressive and tensile loads.

7. The mechanical fuse of claim 1, wherein the first and second crushable elements are annular washers constructed from aluminum honeycomb and like materials.

8. The mechanical fuse of claim 1, wherein a crushed state of the mechanical fuse allows permanent relative axial movement between the inner and outer housings.

9. The mechanical fuse of claim 1, wherein the outer housing is a cylindrical tubular body comprising an end cap.

10. A mechanical fuse adapted for use in a vehicle steering linkage assembly, comprising:
an outer housing;
an inner housing coaxially arranged within the outer housing;
a first crushable element arranged within the outer housing configured to crush under a predetermined maximum axial compressive force on the mechanical fuse; and
a second crushable element arranged within the outer housing spaced from the first crushable element and configured to crush under a predetermined maximum axial tensile force on the mechanical fuse;
wherein axial compressive and tensile forces on the mechanical fuse below the predetermined maximum axial compressive and tensile forces are managed by the inner housing, and wherein relative axial movement between the inner and outer housings occurs in a crushed state of the mechanical fuse thereby imparting play into the mechanical fuse and the vehicle steering linkage assembly.

11. The mechanical fuse of claim 10, wherein the outer housing is fixed to a first half of a rigid link of the vehicle steering linkage assembly and the inner housing is fixed to a second half of the rigid link of the vehicle steering linkage assembly, and wherein the mechanical fuse spaces apart the first and second halves of the rigid link.

12. The mechanical fuse of claim 11, further comprising a first clamp for fixing the outer housing to the first half of the rigid link and a second clamp for fixing the inner housing to the second half of the rigid link.

13. The mechanical fuse of claim 11, wherein the first crushable element in a crushed state provides an air gap between a first end of the inner housing and a first end of the outer housing, and the second crushable element in a crushed state provides an air gap between a second end of the inner housing and a second end of the outer housing.

14. The mechanical fuse of claim 10, wherein the inner housing comprises a spring captured between spaced flanges configured to accommodate forces in the mechanical fuse below the predetermined maximum axial compressive and tensile forces.

15. The mechanical fuse of claim 10, wherein the first and second crushable elements are annular washers constructed from aluminum honeycomb and like materials.

16. A vehicle steering linkage assembly, comprising:
a rigid steering link separated into first and second spaced halves; and
a mechanical fuse interconnecting the first and second spaced halves, the mechanical fuse comprising an outer tubular housing, an inner housing arranged coaxially within the outer tubular housing, and first and second spaced crushable elements arranged at opposing ends of the inner housing configured to crush under respective predetermined maximum axial compressive and tensile forces on the mechanical fuse;
wherein relative axial movement between the inner and outer housings occurs in a crushed state of the mechanical fuse thereby imparting play into the mechanical fuse and the vehicle steering linkage assembly.

17. The vehicle steering linkage assembly of claim 16, wherein the first crushable element is positioned between a first end of the inner housing and a first end of the outer tubular housing, and the second crushable element is positioned between a second end of the inner housing and a second end of the outer tubular housing.

18. The vehicle steering linkage assembly of claim 16, further comprising an end cap removably attached to one end of the outer tubular housing, a first bracket for fixing the outer tubular housing relative to the first half of the rigid steering link, and a second bracket for fixing the inner housing relative to the second half of the rigid steering link.

19. The vehicle steering linkage assembly of claim 16, wherein the first and second crushable elements are annular washers constructed aluminum honeycomb and like materials.

20. The vehicle steering linkage assembly of claim 16, wherein the inner housing comprises a spring captured between spaced flanges configured to accommodate forces in the mechanical fuse below the predetermined maximum axial compressive and tensile forces.
